(19) United States
(12) Patent Application Publication
(10) Pub. No.: US 2025/0157237 A1
(43) Pub. Date: May 15, 2025

(54) METHOD, APPARATUS, READABLE STORAGE MEDIUM AND ELECTRONIC DEVICE FOR IMAGE PROCESSING

(71) Applicant: BEIJING YOUZHUJU NETWORK TECHNOLOGY CO., LTD., Beijing (CN)

(72) Inventors: Xiaofei MAO, Beijing (CN); Can HUANG, Beijing (CN)

(21) Appl. No.: 18/730,493

(22) PCT Filed: Jan. 4, 2023
(86) PCT No.: PCT/CN2023/070261

§ 371 Date: Jul. 19, 2024

(30) Foreign Application Priority Data
Jan. 21, 2022 (CN) 202210074380.8

(51) Int. Cl. G06V 30/12; G06V 20/62; G06V 30/148

(52) U.S. Cl. CPC G06V 30/12; G06V 20/62; G06V 30/148

(57) ABSTRACT

The disclosure relates to a method, apparatus, readable storage medium and electronic device of image processing. The method includes: performing text recognition on a target image, to obtain a recognized text; performing segmentation processing on the recognized text; and obtaining, based on a text segment obtained from the segmentation processing, a target text by correcting the recognized text through a pre-trained language model.

This application claims priority to Chinese Patent Application No. 202210074380.8, filed on Jan. 21, 2022 and entitled “METHOD, APPARATUS, READABLE STORAGE MEDIUM AND ELECTRONIC DEVICE FOR IMAGE PROCESSING”, the disclosure of which is herein incorporated by reference in its entirety.

### FIELD

The present disclosure relates to the field of computer technologies, and in particular to a method, apparatus, readable storage medium and electronic device for image processing.

### BACKGROUND

Along with the information processing technologies in recent years, the performance of an optical character recognition system for text positioning and text recognition based on machine deep learning has been greatly improved, and the accuracy of text recognition in some fields is close to the level of artificial recognition, facilitating implementation in various scenario applications, such as ID card recognition and license plate recognition. It is of great significance how to improve the accuracy of text recognition to adapt to complicated recognition scenarios.

### SUMMARY

The Summary section of the present invention is provided to present the concepts in a brief form, and these concepts will be described in detail in the subsequent Detailed Description section. The Summary section of the present invention is neither intended to identify key or essential features of the claimed technical solutions, nor is it intended to limit the scope of the claimed technical solutions.

In a first aspect, the present disclosure provides a method of image processing, comprising:
performing text recognition on a target image, to obtain a recognized text;
performing segmentation processing on the recognized text; and
obtaining, based on a text segment obtained from the segmentation processing, a target text by correcting the recognized text through a pre-trained language model.

In a second aspect, the present disclosure provides an apparatus for image processing, comprising:
a text recognition module configured to perform text recognition on a target image, to obtain a recognized text;
a segmentation module configured to perform segmentation processing on the recognized text obtained from the text recognition module; and
a correction module configured to obtain, based on a text segment obtained from the segmentation processing by the segmentation module, a target text by correcting the recognized text through a pre-trained language model.

In a third aspect, the present disclosure provides a computer-readable medium storing a computer program thereon, wherein the program, when executed by a processing device, implements the steps of the method of the first aspect of the present disclosure.

In a fourth aspect, the present disclosure provides an electronic device, comprising:
a storage device having a computer program stored thereon; and
a processing device configured to execute the computer program in the storage device to implement the steps of the method of the first aspect of the present disclosure.

In the technical solutions described above, first, text recognition is performed on a target image, to obtain a recognized text; then, segmentation processing is performed on the recognized text; and finally, based on a text segment obtained from the segmentation processing, a target text is obtained by correcting the recognized text through a pre-trained language model. In this way, a text recognition result can be automatically corrected by using prior information such as subject-verb-object collocation and word collocation in the language model, to thereby ensure the accuracy of the text recognition result and the applicability to various complex recognition scenarios. In addition, with the language model, the text recognition result of any text recognition model can be automatically corrected, such that, depending on the scenario, an appropriate text recognition model can be selected for text recognition, which increases the accuracy of recognized text and in turn the efficiency and accuracy of subsequent recognized text correction.

Other features and advantages of the present disclosure will be explained in detail in the following detailed description.

### BRIEF DESCRIPTION OF THE SEVERAL VIEWS OF THE DRAWINGS

The above and other features, advantages, and aspects of the embodiments of the present disclosure will become more apparent in combination with the accompanying drawings and with reference to the following detailed description. In the drawings, the same or similar reference symbols refer to the same or similar elements. It should be understood that the drawings are schematic, and the components and elements are not necessarily drawn to scale. In the accompanying drawings:

FIG. 1 illustrates a flowchart of a method of image processing according to an example embodiment;

FIG. 2 is a flowchart of a method of obtaining, based on a text segment obtained from the segmentation processing, a target text by correcting the recognized text through a pre-trained language model according to an example embodiment;

FIG. 3 illustrates a flowchart of a method of image processing according to another example embodiment;

FIG. 4 is a flowchart of a method of obtaining, based on a text segment obtained from the segmentation processing, a target text by correcting the recognized text through a pre-trained language model according to another example embodiment;

FIG. 5 illustrates a block diagram of an apparatus for image processing according to an example embodiment; and

FIG. 6 illustrates a block diagram of an electronic device according to an example embodiment.

### DETAILED DESCRIPTION

The embodiments of the present disclosure will be described in more detail below with reference to the accompanying drawings. Although the drawings show some embodiments of the present disclosure, it should be understood that the present disclosure can be implemented in a variety of forms and should not be construed as confined to the embodiments set forth herein. On the contrary, these embodiments are provided for a more thorough and complete understanding of the present disclosure. It should be understood that the drawings and embodiments of the present disclosure are only for illustrative purposes and are not intended to limit the scope of protection of the present disclosure.

It should be understood that the steps described in the method implementations of the present disclosure can be executed in different sequences and/or in parallel. In addition, the method implementations may comprise additional steps and/or the steps shown for the execution may be omitted. The scope of the present disclosure is not limited in this regard.

The term “comprise”, and its variants as used herein are open-ended, indicating “comprising but not limited to”. The term “based on” is to be interpreted as “at least partially based on”. The term “an embodiment” indicates “at least one embodiment”; the term “another embodiment” indicates “at least one additional embodiment”; and the term “some embodiments” indicates “at least some embodiments”. The related definitions of other terms will be given in the description below.

It should be noted that the concepts “first”, “second” or the like mentioned in the present disclosure are only intended to distinguish different apparatuses, modules, or units, and are not intended to limit the order or interdependence of the functions performed by these apparatuses, modules, or units.

It should be noted that the modifications with “one” and “a plurality of” mentioned in the present disclosure are for an illustrative purpose rather than a restrictive purpose, and those skilled in the art should understand that they should be understood as “one or more”, unless otherwise expressly indicated in the context.

In the implementations of the present disclosure, the names of messages or information exchanged between a plurality of apparatus are only for illustrative purposes and are not intended to limit the scope of such messages or information.

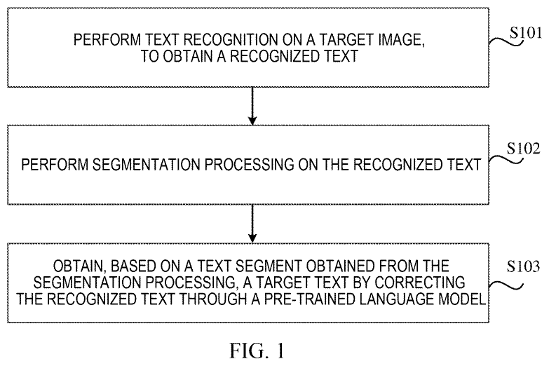

FIG. 1 illustrates a flowchart of a method of image processing according to an example embodiment. FIG. 1 is a flowchart illustrating a method of image processing according to an example embodiment. As shown in FIG. 1, the method comprises S101 to S103.

In S101, text recognition is performed on a target image, to obtain a recognized text.

In the present disclosure, a target image comprises text information, which may be in Chinese, English or numerical, etc., and the present disclosure does not specifically limit the type of language of the text information comprised in the target image.

In addition, the target image may be inputted into a pre-trained text recognition model to obtain a recognized text, wherein the text recognition model may be, for example, a convolutional recurrent neural network, an attention mechanism-based codec network, or the like.

In S102, segmentation processing is performed on the recognized text.

In S103, based on a text segment obtained from the segmentation processing, a target text is obtained by correcting the recognized text through a pre-trained language model.

In the present disclosure, the above-mentioned language models may be, for example a Generative Pre-Training (GPT2) model, a Bidirectional Encoder Representation from Transformers (BERT), Embeddings from Language Models (ELMo) or the like.

In the technical solutions described above, first, text recognition is performed on a target image, to obtain a recognized text; then, segmentation processing is performed on the recognized text; and finally, based on a text segment obtained from the segmentation processing, a target text is obtained by correcting the recognized text through a pre-trained language model. In this way, a text recognition result can be automatically corrected by using prior information such as subject-verb-object collocation and word collocation in the language model, to thereby ensure the accuracy of the text recognition result and the applicability to various complex recognition scenarios. In addition, with the language model, the text recognition result of any text recognition model can be automatically corrected, such that, depending on the various scenarios, an appropriate text recognition model can be selected for text recognition, which increases the accuracy of recognized text and in turn the efficiency and accuracy of subsequent recognized text correction.

The specific structure of the above-mentioned attention mechanism-based codec network is described in detail. In an implementation, the above-mentioned attention mechanism-based codec network may comprise a preprocessing module, a feature extraction module, an attention mechanism-based encoding module, a decoding module, and a fully connected layer, which are connected in sequence.

Herein, the preprocessing module is configured to adjust the target image to a first predetermined size (for example, 32*384), and then partition the size-adjusted target image by a second predetermined size (for example, 16*16) into a plurality of image blocks; the feature extraction module is configured to perform feature extraction on the plurality of image blocks to obtain first feature vectors corresponding to the target image; the attention mechanism-based encoding module is configured to encode the first feature vectors to obtain an encoded sequence; the decoding module is configured to decode the encoded sequence to obtain second feature vectors corresponding to the target image; and the fully connected layer is configured to generate, based on the second feature vectors, the recognized text corresponding to the target image.

Herein, the feature extraction module may be composed of a plurality of convolutional neural networks (CNNs). The attention mechanism-based encoding module may be composed of an encoding network and an attention network and may also be composed of a plurality of sequentially connected encoding networks and attention networks. In some examples, the encoding module comprises a plurality of sequentially connected encoding networks, such that the accuracy of text recognition can be improved.

The specific implementation of performing segmentation processing on the recognized text in S102 is described in detail below. Specifically, segmentation processing may be performed on the recognized text obtained in S101 by at least one of three segmentation modes as follows.
(1) Segmentation is performed on the recognized text by characters.

For example, in the case of a recognized text “dOcum3nt to coRrect”, segmentation is performed on it by characters to obtain three text segments: “dOcum3nt”, “to”, and “coRrect”.
(2) Segmentation is performed on the recognized text by a first predetermined length.

In the present disclosure, wherein the first predetermined length is greater than 1.

For example, in the case of a recognized text “dOcum3nt to coRrect” and the first predetermined length of 5, segmentation is performed on it by the first predetermined length to obtain the following four text segments: “dOcum”, “3nt t” (i.e., 3nt+space+t), “o coR” (i.e., o+space+coR), and “rect”.
(3) Segmentation is performed on the recognized text by a sliding window of a second predetermined length, wherein the second predetermined length is greater than 1.

For example, in the case of a recognized text “dOcum3nt to coRrct” and the second predetermined length of 4, segmentation is performed on it by the sliding window of a second predetermined length to obtain the following fifteen text segments: “dOcu”, “Ocum”, “cum3”, “um3n”, “m3nt”, “3nt “(i.e., 3nt+space), “nt t” (i.e., nt+space+t), “t to” (i.e., t+space+to), “to” (i.e., space+to+space), “to c” (i.e., to+space+c), “o co” (i.e., o+space+co), “coR” (i.e., space+coR), “coRr”, “oRrc”, and “Rrct”.

The specific implementation of” segmentation being performed on the recognized text by a first predetermined length in (2) is described in detail below. Specifically, this can be done in a variety of ways. In an implementation, segmentation is performed on the recognized text by the first predetermined length sequentially from beginning to end.

In another implementation, segmentation is performed on the recognized text with an N-gram model, i.e., inputting the recognized text into the N-gram model to perform segmentation on the recognized text, wherein N is the first predetermined length. In this way, the efficiency of recognized text segmentation can be improved, in particular for segmentation of long recognized text.

For example, in the case where the first predetermined length is 5, the N-gram model is a 5-gram model.

The specific implementation of based on a text segment obtained from the segmentation processing, a target text is obtained by correcting the recognized text through a pre-trained language model in S103 is described in detail below.

In the present disclosure, this can be done in variety of ways. In an implementation, the text segment obtained from the segmentation processing may be inputted into the pre-trained language model, to correct the recognized text and obtain the target text.

Specifically, when segmentation is performed on the recognized text in S102 in the segmentation mode of (1), the text segment obtained from the segmentation processing comprises at least one text segment obtained from segmentation in the segmentation mode of (1). Here, the at least one text segment obtained from segmentation in the segmentation mode of (1) may be inputted into the pre-trained language model, to correct the recognized text and obtain the target text.

When segmentation is performed on the recognized text in S102 in the segmentation mode of (2), the text segment obtained from the segmentation processing comprise at least one text segment obtained from segmentation in the segmentation mode of (2). Here, the at least one text segment obtained from segmentation in the segmentation mode of (2) may be inputted into the pre-trained language model, to correct the recognized text and obtain the target text.

When segmentation is performed on the recognized text in S102 in the segmentation mode of (3), the text segment obtained from the segmentation processing comprise at least one text segment obtained from segmentation in the segmentation mode of (3). Here, the at least one text segment obtained from segmentation in the segmentation mode of (3) may be inputted into the pre-trained language model, to correct the recognized text and obtain the target text.

When segmentation is performed on the recognized text in S102 in the segmentation modes of (1) and (3), respectively, the text segments obtained from the segmentation processing comprise at least one text segment obtained from segmentation in the segmentation mode of (1) and at least one text segment obtained from segmentation in the segmentation mode of (3). Here, the text segments obtained from segmentation in the segmentation modes of (1) and (3) may be inputted into the pre-trained language model, to correct the recognized text and obtain the target text.

When segmentation is performed on the recognized text in S102 in the segmentation modes of (1) and (2), respectively, the text segments obtained from the segmentation processing comprise at least one text segment obtained from segmentation in the segmentation mode of (1) and at least one text segment obtained from segmentation in the segmentation mode of (2). Here, the text segments obtained from segmentation in the segmentation modes of (1) and (2) may be inputted into the pre-trained language model, to correct the recognized text and obtain the target text.

When segmentation is performed on the recognized text in S102 in the segmentation modes of (2) and (3), respectively, the text segments obtained from the segmentation processing comprise at least one text segment obtained from segmentation in the segmentation mode of (2) and at least one text segment obtained from segmentation in the segmentation mode of (3). Here, the text segments obtained from segmentation in the segmentation modes of (2) and (3) may be inputted into the pre-trained language model, to correct the recognized text and obtain the target text.

When segmentation is performed on the recognized text in S102 in the segmentation modes of (1), (2) and (3), respectively, the text segments obtained from the segmentation processing comprise at least one text segment obtained from segmentation in the segmentation mode of (1), at least one text segment obtained from segmentation in the segmentation mode of (2) and at least one text segment obtained from segmentation in the segmentation mode of (3). Here, the text segments obtained from segmentation in the above three segmentation modes may be inputted into the pre-trained language model, to correct the recognized text and obtain the target text.

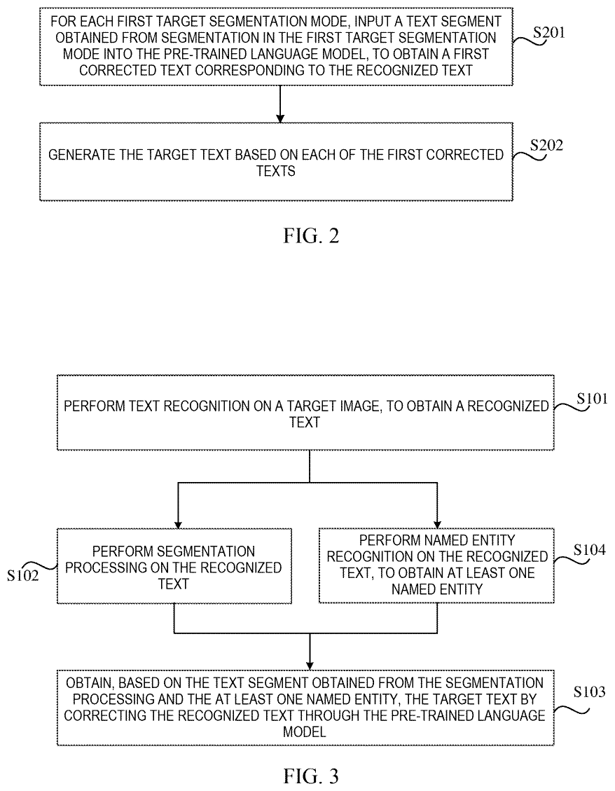

In another implementation, when segmentation processing is performed on the recognized text in at least two of the above three segmentation modes, i.e., when segmentation is performed on the recognized text in S102 in at least two of the segmentation modes of (1), (2) and (3), the target text may be obtained, based on the text segments obtained from segmentation processing, from correcting the recognized text through the pre-trained language model according to S201 and S202 shown in FIG. 2.

In S201, for each first target segmentation mode, the text segment obtained from segmentation in the first target segmentation mode is input into the pre-trained language model, to obtain a first corrected text corresponding to the recognized text.

In the present disclosure, the first target segmentation mode is a segmentation mode adopted in the segmentation processing of the recognized text.

In S202, the target text is generated based on each of the first corrected texts.

As an example, in the case where the segmentation modes of (1) and (2) are used in S102 to perform segmentation on the recognized text respectively, the first target segmentation modes comprise the segmentation modes of (1) and (2). Here, the text segment obtained from segmentation in the segmentation mode of (1) may be inputted into the pre-trained language model, to obtain a first corrected text; the text segment obtained from segmentation in the segmentation mode of (2) may be inputted into the pre-trained language model, to obtain another first corrected text; and then, the target text is generated based on the two first corrected texts.

As another example, in the case where the segmentation modes of (1), (2) and (3) are used in S102 to perform segmentation on the recognized text respectively, the first target segmentation modes comprise the segmentation modes of (1), (2) and (3). Here, the text segment obtained from segmentation in the segmentation mode of (1) may be inputted into the pre-trained language model, to obtain a first corrected text; the text segment obtained from segmentation in the segmentation mode of (2) may be inputted into the pre-trained language model, to obtain another first corrected text; the text segment obtained from segmentation in the segmentation mode of (3) may be inputted into the pre-trained language model, to obtain still another first corrected text; and then, the target text is generated based on the three first corrected texts.

In the above implementation, the text segments of different grains may be obtained depending on the segmentation mode. In this way, the recognized text is corrected based on the text segments of different grains with the language model, and the target text is generated based on the respective corrected texts, such that the accuracy of a text recognition result can be increased.

The specific implementation of generating the target text based on each of the first corrected texts in 202 is described in detail below. Specifically, this can be done in variety of ways. In an implementation, a first corrected text with a highest confidence among respective ones of the first corrected texts is determined as the target text, wherein the confidence of the corresponding first corrected text is accordingly output while each of the first corrected texts is generated by the language model.

In another implementation, the first corrected text with the highest confidence among the respective ones of the first corrected texts is inputted into the language model to obtain the target text.

In this implementation, the recognized text is re-corrected based on the first corrected text with the highest confidence among respective ones of the first corrected texts with the language model, which can further increase the accuracy of the text recognition result.

In still another implementation, each of the first corrected texts is inputted into the language model to obtain the target text.

In this implementation, the recognized text is re-corrected based on each of the first corrected texts with the language model, which can further increase the accuracy of the text recognition result.

FIG. 3 illustrates a flowchart of a method of image processing according to another example embodiment. As shown in FIG. 3, the method may further comprise S104 below.

In S104, named entity recognition is performed on the recognized text, to obtain at least one named entity.

Here, in S103, based on the text segment obtained from the segmentation processing and the at least one named entity, the target text is obtained by correcting the recognized text through the pre-trained language model. In this way, the accuracy of the text recognition result can be further increased.

The specific implementation of based on the text segment obtained from the segmentation processing and the at least one named entity, the target text is obtained by correcting the recognized text through the pre-trained language model is described in detail below. Specifically, this can be done in variety of ways. In an implementation, inputting the text segment obtained from the segmentation processing and the at least one named entity into the pre-trained language model, to correct the recognized text and obtain the target text.

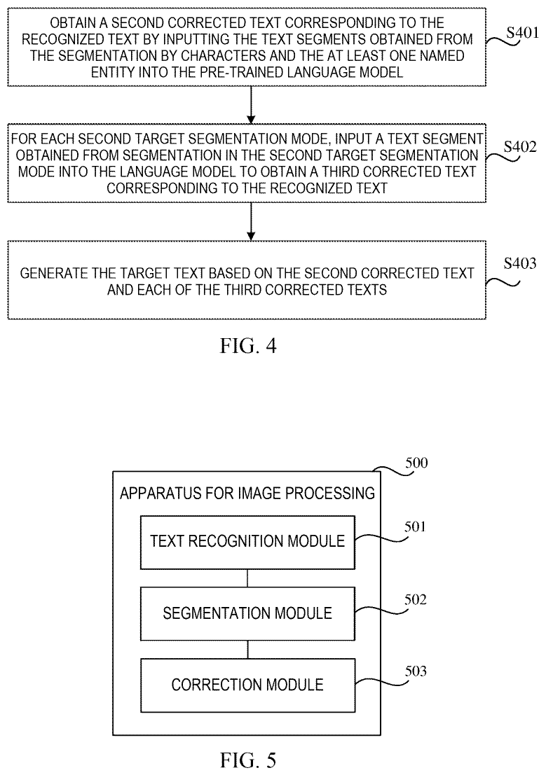

In another implementation, performing segmentation processing on the recognized text comprises: performing segmentation on the recognized text by characters; and
performing segmentation on the recognized text by a first predetermined length, and/or by a sliding window of a second predetermined length, i.e., segmentation is performed on the recognized text in S102 in at least one of the above two segmentation modes of (2) and (3) and in the segmentation mode of (1), correcting the recognized text through the pre-trained language model according to S401 to S403 shown in FIG. 4 to obtain the target text, based on the text segments obtained from segmentation processing and the above at least one named entity.

In S401, a second corrected text corresponding to the recognized text is obtained by inputting the text segments obtained from the segmentation by characters and the at least one named entity into the pre-trained language model.

Specifically, the second corrected text corresponding to the recognized text may be obtained by inputting the text segments obtained from segmentation in the segmentation mode of (1) and the at least one named entity obtained in S104, into the pre-trained language model. In this way, the recognized text is corrected based on both the text segment obtained from segmentation by characters and the at least one named entity, which can increase the accuracy of text correction.

In S402, for each second target segmentation mode, a text segment obtained from segmentation in the second target segmentation mode is inputted into the language model to obtain a third corrected text corresponding to the recognized text.

In the present disclosure, the second segmentation mode is another segmentation mode adopted in the segmentation processing of the recognized text, other than the mode for segmenting the recognized text by characters. I.e., the second target segmentation mode is another segmentation mode adopted in the segmentation processing of the recognized text, other than the segmentation mode of (1).

In S403, the target text is generated based on the second corrected text and each of the third corrected texts.

In the present disclosure, the target text may be generated based on the second corrected text and each of the third corrected texts in a manner similar to that adopted in S202 above where the target text is generated based on each of the first corrected texts, and the details will not be repeated in the present disclosure.

As an example, in the case where the segmentation modes of (1) and (2) are used in S102 to perform segmentation on the recognized text respectively, the second target segmentation modes comprise the segmentation modes of (2). Here, the text segment obtained from segmentation in the segmentation mode of (1) and the at least one named entity obtained in S104 may be inputted into the pre-trained language model, to obtain a second corrected text; the text segment obtained from segmentation in the segmentation mode of (2) may be inputted into the pre-trained language model, to obtain a third corrected text; and then, the target text is generated based on the second corrected text and the third corrected text.

As another example, in the case where the segmentation modes of (1), (2) and (3) are used in S102 to perform segmentation on the recognized text respectively, the second target segmentation modes comprise the segmentation modes of (2) and (3). Here, the text segment obtained from segmentation in the segmentation mode of (1) and the at least one named entity obtained in S104 may be inputted into the pre-trained language model, to obtain a second corrected text; the text segment obtained from segmentation in the segmentation mode of (2) may be inputted into the pre-trained language model, to obtain a third corrected text; the text segment obtained from segmentation in the segmentation mode of (3) may be inputted into the pre-trained language model, to obtain another third corrected text; and then, the target text is generated based on the second corrected text and the above two third corrected texts.

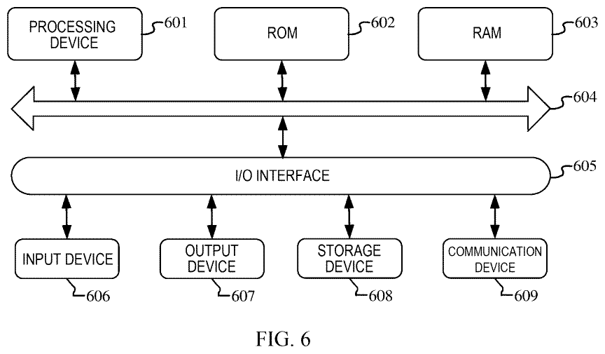

FIG. 5 illustrates a block diagram of an apparatus for image processing according to an example embodiment. As shown in FIG. 5, the apparatus 500 may comprise:
a text recognition module 501 configured to perform text recognition on a target image, to obtain a recognized text;
a segmentation module 502 configured to perform segmentation processing on the recognized text obtained from the text recognition module 501; and
a correction module 503 configured to obtain, based on a text segment obtained from the segmentation processing by the segmentation module 502, a target text by correcting the recognized text through a pre-trained language model.

In the technical solutions described above, first, text recognition is performed on a target image, to obtain a recognized text; then, segmentation processing is performed on the recognized text; and finally, based on a text segment obtained from the segmentation processing, a target text is obtained by correcting the recognized text through a pre-trained language model. In this way, a text recognition result can be automatically corrected by using prior information such as subject-verb-object collocation and word collocation in the language model, to thereby ensure the accuracy of the text recognition result and the applicability to various complex recognition scenarios. In addition, with the language model, the text recognition result of any text recognition model can be automatically corrected, such that, depending on the various scenarios, an appropriate text recognition model can be selected for text recognition, which increases the accuracy of recognized text and in turn the efficiency and accuracy of subsequent recognized text correction.

In some embodiments, the segmentation module 502 comprises at least one of:
a first segmentation sub-module configured for performing segmentation on the recognized text by characters;
a second segmentation sub-module configured for performing segmentation on the recognized text by a first predetermined length, wherein the first predetermined length is greater than 1; and
a third segmentation sub-module configured for performing segmentation on the recognized text by a sliding window of a second predetermined length, wherein the second predetermined length is greater than 1.

In some embodiments, the segmentation module 502 comprises at least two of the first segmentation sub-module, the second segmentation sub-module, and the third segmentation sub-module.

The correction module 503 comprises:
a correction sub-module configured for, for each first target segmentation mode, inputting a text segment obtained from segmentation in the first target segmentation mode into the pre-trained language model, to obtain a first corrected text corresponding to the recognized text, wherein the first target segmentation mode is a segmentation mode adopted in the segmentation processing of the recognized text; and
a first generation sub-module configured for generating the target text based on each of the first corrected texts.

In some embodiments, the first generation sub-module comprises any of:
a determination sub-module configured for determining a first corrected text with a highest confidence among respective ones of the first corrected texts as the target text;
a first input sub-module configured for inputting the first corrected text with the highest confidence among the respective ones of the first corrected texts into the language model to obtain the target text; and
a second input sub-module configured for inputting each of the first corrected texts into the language model to obtain the target text.

In some embodiments, the correction module 503 is configured for inputting the text segment obtained from the segmentation processing into the pre-trained language model, to correct the recognized text and obtain the target text.

In some embodiments, the apparatus 500 further comprises:
a named entity recognition module configured for performing named entity recognition on the recognized text, to obtain at least one named entity; and
the correction module 503 is configured for obtaining, based on the text segment obtained from the segmentation processing and the at least one named entity, the target text by correcting the recognized text through the pre-trained language model.

In some embodiments, the segmentation module 502 comprises:
a first segmentation sub-module configured for performing segmentation on the recognized text by characters;
a second segmentation sub-module configured for performing segmentation on the recognized text by a first predetermined length, and/or a third segmentation sub-module configured for performing segmentation on the recognized text by a sliding window of a second predetermined length, wherein the first predetermined length and the second predetermined length are each greater than 1.

The correction module 503 comprises:
a third input sub-module configured for obtaining a second corrected text corresponding to the recognized text by inputting the text segments obtained from the segmentation by characters and the at least one named entity into the pre-trained language model;
a fourth input sub-module configured for, for each second target segmentation mode, inputting a text segment obtained from segmentation in the second target segmentation mode into the language model to obtain a third corrected text corresponding to the recognized text, wherein the second target segmentation mode is a segmentation mode adopted in the segmentation processing of the recognized text other than the mode for segmenting the recognized text by characters; and
a second generation sub-module configured for generating the target text based on the second corrected text and each of the third corrected texts.

In some embodiments, the correction module 503 is configured for correcting the recognized text and obtaining the target text, by inputting the text segment obtained from the segmentation processing and the at least one named entity into the pre-trained language model.

In some embodiments, the second segmentation sub-module is configured for performing segmentation on the recognized text with an N-gram model, wherein N is the first predetermined length.

The present disclosure further provides a computer-readable medium storing a computer program thereon, wherein the program, when executed by a processing device, implements the steps of the method of image processing according to the present disclosure.

Reference is made below to FIG. 6, which shows the schematic structural diagram of an electronic device (terminal device or server) 600 adapted to implement the embodiment of the present disclosure. The terminal device in the embodiment of the present disclosure may comprise, but is not limited to, mobile terminals such as mobile phones, laptop computers, digital radio receivers, personal digital assistants (PDAs), portable Android devices (PADs), portable multimedia players (PMPs), and vehicle-mounted terminals (for example, vehicle-mounted navigation terminals), as well as fixed terminals such as digital televisions and desktop computers. The electronic device shown in FIG. 6 is merely an example and is not intended to impose any limitation to the functionality and application scope of the embodiment of the present invention.

As shown in FIG. 6, the electronic device 600 comprises a processing device (for example, a central processing unit, an image processor, or the like) 601, which may execute various appropriate actions and processing according to a program stored in a read-only memory (ROM) 602 or a program loaded from a storage device 608 to a random access memory (RAM) 603. The RAM 603 further stores various programs and data necessary for operating the electronic device 600. The processing device 601, the ROM 602, and the RAM 603 are connected to one another through a bus 604. An input/output (I/O) interface 605 is also connected to the bus 604.

In general, the devices that can be connected to the I/O interface 605 are as follows: input devices 606, comprising, for example, touch screens, touchpads, keyboards, mice, cameras, microphones, accelerometers, gyroscopes or the like; output devices 607, comprising, for example, liquid crystal displays (LCDs), speakers, vibrators or the like; storage devices 608, comprising, for example, magnetic tapes, hard disks or the like; and communication devices 609. The communication devices 609 may allow electronic device 600 to communicate with other devices, wirelessly or over wires, for the exchange of data. Although FIG. 6 shows the electronic device 600 with various apparatus, it should be understood that it is not required to implement or provide all of the apparatus shown. More or fewer devices may be alternatively implemented or provided.

In particular, according to the embodiment of the present disclosure, the process described above with reference to the flowchart may be implemented as a computer software program. For example, an embodiment of the present disclosure comprises a computer program product, which comprises a computer program carried on a non-transient computer-readable medium, and the computer program comprises program codes for executing the method shown in the flowchart. In such an embodiment, the computer program may be downloaded and installed from a network through the communication devices 609, or installed from the storage devices 608, or installed from the ROM 602. When the computer program is executed by the processing device 601, the functions defined in the method according to the embodiment of the present disclosure are executed.

It should be noted that the computer-readable medium of the present disclosure may be a computer-readable signal medium, a computer-readable storage medium, or any combination of the above two. For example, the computer-readable storage medium may be, but not limited to, an electrical, magnetic, optical, electromagnetic, infrared, or semiconductor-based system, apparatus or device, or a combination of any of the above. More specific examples of the computer-readable storage medium may comprise, but not limited to: an electrical connection having one or more leads, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program, which can be used by or in combination with an instruction execution system, apparatus, or device. In the present disclosure, the computer-readable signal medium may comprise a data signal propagating in a baseband or as part of a carrier, where a computer-readable program code is carried. The data signal propagating in such a way may take a variety of forms, comprising but not limited to an electromagnetic signal, an optical signal, or any suitable combination of the above. The computer-readable signal medium may further be any computer-readable medium other than a computer-readable storage medium. The computer-readable medium may send, propagate, or transmit a program used by or in combination with an instruction execution system, apparatus, or device. The program code comprised in the computer-readable medium may be transmitted by using any suitable medium, comprising but not limited to: wires, optical cables, radio frequency (RF) and the like, or any suitable combination of the above.

In some implementations, a client and a server may communicate using any currently known or future-developed network protocol such as Hyper Text Transfer Protocol (HTTP) and may be interconnected with digital data communication (e.g., communication networks) in any form or medium. Examples of the communication networks comprise local area networks (“LANs”), wide area networks (“WANs”), internetworks (for example, Internet), and end-to-end networks (for example, ad hoc end-to-end networks), as well as any currently known or future-developed networks.

Such a computer-readable medium may be comprised in the above-mentioned electronic device or may exist on its own without assembly into the electronic device.

The computer-readable medium carries one or more programs, which, when executed by the electronic device, causes the electronic device to: obtain a recognized text by performing text recognition on a target image; perform segmentation processing on the recognized text; and obtain a target text by correcting the recognized text through a pre-trained language model based on a text segment obtained from the segmentation processing.

The computer program code for executing the operation of the present disclosure may be written in one or more programming languages or their combinations. The programming languages comprise, but are not limited to, object-oriented programming languages such as Java, Smalltalk, and C++, as well as conventional procedural programming languages such as “C” language or similar programming languages. The program code may be executed entirely on a user computer, partially on the user computer, as a stand-alone software package, partially on the user computer and partially on a remote computer, or entirely on the remote computer or a server. In a case where the remote computer is involved, the remote computer may be connected to the user computer via any type of network comprising a local area network (LAN) or a wide area network (WAN) or may be connected to an external computer (for example, via Internet by virtue of an Internet service provider).

The flowchart and block diagram in the accompanying drawings illustrate the architecture, functions, and operations that may be achieved according to the systems, methods, and computer program products in various embodiments of the present disclosure. In this regard, each box in the flowchart or block diagram may represent a module, program segment, or part of code that contains one or more executable instructions for fulfilling a specified logical function. It should also be noted that, in some alternative implementations, the functions labeled in the boxes can also occur in a different order than those labeled in the drawings. For example, two boxes represented in succession may actually be executed in a substantially parallel order, and they can sometimes be executed in a reverse order, depending on the function involved. It should also be noted that each box in the block diagram and/or flowchart, and a combination of the boxes in the block diagram and/or flowchart, may be implemented with a dedicated hardware-based system that performs a specified function or operation, or with a combination of special-purpose hardware and computer instructions.

The modules involved in the description of the embodiments of the present disclosure may be implemented through software or hardware. Under certain circumstances, the name of a module does not impose limitation to the module itself. Tor example, the segmentation module may also be described as a “module for performing segmentation processing on the recognized text”.

The functions described above herein may be fulfilled at least in part by one or more hardware logical components. For example, without limitation, the example types of hardware logical components that can be used comprise: a field programmable gate array (FPGA), an application-specific integrated circuit (ASIC), an application-specific standard product (ASSP), a system on chip (SOC), a complex programmable logic device (CPLD), etc.

In the context of the present disclosure, a machine-readable medium may be a tangible medium which may comprise or store a program to be used by or in combination with an instruction execution system, apparatus, or device. The machine-readable medium may be a machine-readable signal medium or a machine-readable storage medium. The machine-readable medium may comprise, but is not limited to, electronic, magnetic, optical, electromagnetic, infrared, or semiconductor-based systems, apparatuses, or devices, or any suitable combination of the above. More specific examples of the machine-readable storage medium comprise: an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, Example 1 provides a method of image processing, comprising: performing text recognition on a target image, to obtain a recognized text; performing segmentation processing on the recognized text; and obtaining, based on a text segment obtained from the segmentation processing, a target text by correcting the recognized text through a pre-trained language model.

According to one or more embodiments of the present disclosure, Example 2 provides the method of Example 1, wherein performing segmentation processing on the recognized text comprises at least one of three segmentation modes: performing segmentation on the recognized text by characters; performing segmentation on the recognized text by a first predetermined length, wherein the first predetermined length is greater than 1; and performing segmentation on the recognized text by a sliding window of a second predetermined length, wherein the second predetermined length is greater than 1.

According to one or more embodiments of the present disclosure, Example 3 provides the method of Example 2, wherein performing segmentation processing on the recognized text comprises at least two of the three segmentation modes; and obtaining, based on a text segment obtained from the segmentation processing, a target text by correcting the recognized text through a pre-trained language model comprises: for each first target segmentation mode, inputting a text segment obtained from segmentation in the first target segmentation mode into the pre-trained language model, to obtain a first corrected text corresponding to the recognized text, wherein the first target segmentation mode is a segmentation mode adopted in the segmentation processing of the recognized text; and generating the target text based on each of the first corrected texts.

According to one or more embodiments of the present disclosure, Example 4 provides the method of Example 3, wherein generating the target text based on each of the first corrected texts comprises any of: determining a first corrected text with a highest confidence among respective ones of the first corrected texts as the target text; inputting the first corrected text with the highest confidence among the respective ones of the first corrected texts into the language model to obtain the target text; and inputting each of the first corrected texts into the language model to obtain the target text.

According to one or more embodiments of the present disclosure, Example 5 provides the method of Example 1 or 2, wherein obtaining, based on a text segment obtained from the segmentation processing, a target text by correcting the recognized text through a pre-trained language model comprises: inputting the text segment obtained from the segmentation processing into the pre-trained language model, to correct the recognized text and obtain the target text.

According to one or more embodiments of the present disclosure, Example 6 provides the method of Example 1, wherein the method further comprises: performing named entity recognition on the recognized text, to obtain at least one named entity; and obtaining, based on a text segment obtained from the segmentation processing, a target text by correcting the recognized text through a pre-trained language model comprises: obtaining, based on the text segment obtained from the segmentation processing and the at least one named entity, the target text by correcting the recognized text through the pre-trained language model.

According to one or more embodiments of the present disclosure, Example 7 provides the method of Example 6, wherein performing segmentation processing on the recognized text comprises: performing segmentation on the recognized text by characters; and performing segmentation on the recognized text by a first predetermined length, and/or by a sliding window of a second predetermined length, wherein the first predetermined length and the second predetermined length are each greater than 1; and obtaining, based on the text segment obtained from the segmentation processing and the at least one named entity, the target text by correcting the recognized text through the pre-trained language model comprises: obtaining a second corrected text corresponding to the recognized text by inputting the text segments obtained from the segmentation by characters and the at least one named entity into the pre-trained language model; for each second target segmentation mode, inputting a text segment obtained from segmentation in the second target segmentation mode into the language model to obtain a third corrected text corresponding to the recognized text, wherein the second target segmentation mode is a segmentation mode adopted in the segmentation processing of the recognized text other than the mode for segmenting the recognized text by characters; and generating the target text based on the second corrected text and each of the third corrected texts.

According to one or more embodiments of the present disclosure, Example 8 provides the method of Example 6, wherein obtaining the target text by correcting the recognized text through the pre-trained language model based on the text segment obtained from the segmentation processing and the at least one named entity comprises: correcting the recognized text and obtaining the target text, by inputting the text segment obtained from the segmentation processing and the at least one named entity into the pre-trained language model.

According to one or more embodiments of the present disclosure, Example 9 provides the method of any of Examples 2-4 and 7, wherein performing segmentation on the recognized text by a first predetermined length comprises: performing segmentation on the recognized text with an N-gram model, wherein N is the first predetermined length.

According to one or more embodiments of the present disclosure, Example 10 provides an apparatus for image processing, comprising: a text recognition module configured to perform text recognition on a target image, to obtain a recognized text; a segmentation module configured to perform segmentation processing on the recognized text obtained from the text recognition module; and a correction module configured to obtain, based on a text segment obtained from the segmentation processing by the segmentation module, a target text by correcting the recognized text through a pre-trained language model.

According to one or more embodiments of the present disclosure, Example 11 provides a computer-readable medium storing a computer program thereon, wherein the program, when executed by a processing device, implements the steps of the method of any of Examples 1-9.

According to one or more embodiments of the present disclosure, Example 12 provides an electronic device, comprising: a storage device having a computer program stored thereon; and a processing device configured to execute the computer program in the storage device to implement the steps of the method of any of Examples 1-9.

The above description is only a preferred embodiment of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept, for example, a technical solution formed by interchanging the above features with (but not limited to) technical features with similar functions disclosed in the present disclosure.

Furthermore, while the operations are depicted using a particular order, this should not be construed as requiring that the operations are performed in the particular order shown or in sequential order of execution. Multitasking and parallel processing may be advantageous in certain environments. Similarly, while several specific implementation details are comprised in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or method logical actions, it should be understood that the subject matter limited in the appended claims is not necessarily limited to the particular features or actions described above. Rather, the particular features and actions described above are merely example forms of implementing the claims. With respect to the apparatus in the above embodiments, the specific manner in which the individual modules perform the operations has been described in detail in the embodiments relating to the method and will not be described in detail herein.

1. A method of image processing, comprising:
performing text recognition on a target image, to obtain a recognized text;
performing segmentation processing on the recognized text; and
obtaining, based on a text segment obtained from the segmentation processing, a target text by correcting the recognized text through a pre-trained language model.

2. The method of claim 1, wherein performing segmentation processing on the recognized text comprises at least one of three segmentation modes:
performing segmentation on the recognized text by characters;
performing segmentation on the recognized text by a first predetermined length, wherein the first predetermined length is greater than 1; and
performing segmentation on the recognized text by a sliding window of a second predetermined length, wherein the second predetermined length is greater than 1.

3. The method of claim 2, wherein performing segmentation processing on the recognized text comprises at least two of the three segmentation modes; and
obtaining, based on a text segment obtained from the segmentation processing, a target text by correcting the recognized text through a pre-trained language model comprises:
for each first target segmentation mode, inputting a text segment obtained from segmentation in the first target segmentation mode into the pre-trained language model, to obtain a first corrected text corresponding to the recognized text, wherein the first target segmentation mode is a segmentation mode adopted in the segmentation processing of the recognized text; and
generating the target text based on each of the first corrected texts.

4. The method of claim 3, wherein generating the target text based on each of the first corrected texts comprises any of:
determining a first corrected text with a highest confidence among respective ones of the first corrected texts as the target text;
inputting the first corrected text with the highest confidence among the respective ones of the first corrected texts into the language model to obtain the target text; and
inputting each of the first corrected texts into the language model to obtain the target text.

5. The method of claim 1, wherein obtaining, based on a text segment obtained from the segmentation processing, a target text by correcting the recognized text through a pre-trained language model comprises:
inputting the text segment obtained from the segmentation processing into the pre-trained language model, to correct the recognized text and obtain the target text.

6. The method of claim 1, further comprising:
performing named entity recognition on the recognized text, to obtain at least one named entity; and
obtaining, based on a text segment obtained from the segmentation processing, a target text by correcting the recognized text through a pre-trained language model comprises:
obtaining, based on the text segment obtained from the segmentation processing and the at least one named entity, the target text by correcting the recognized text through the pre-trained language model.

7. The method of claim 6, wherein performing segmentation processing on the recognized text comprises:
performing segmentation on the recognized text by characters; and
performing segmentation on the recognized text by a first predetermined length, and/or by a sliding window of a second predetermined length, wherein the first predetermined length and the second predetermined length are each greater than 1; and
obtaining, based on the text segment obtained from the segmentation processing and the at least one named entity, the target text by correcting the recognized text through the pre-trained language model comprises:
obtaining a second corrected text corresponding to the recognized text by inputting the text segments obtained from the segmentation by characters and the at least one named entity into the pre-trained language model;
for each second target segmentation mode, inputting a text segment obtained from segmentation in the second target segmentation mode into the language model to obtain a third corrected text corresponding to the recognized text, wherein the second target segmentation mode is a segmentation mode adopted in the segmentation processing of the recognized text other than the mode for segmenting the recognized text by characters; and
generating the target text based on the second corrected text and each of the third corrected texts.

8. The method of claim 6, wherein obtaining the target text by correcting the recognized text through the pre-trained language model based on the text segment obtained from the segmentation processing and the at least one named entity comprises:
correcting the recognized text and obtaining the target text, by inputting the text segment obtained from the segmentation processing and the at least one named entity into the pre-trained language model.

9. The method of claim 2, wherein performing segmentation on the recognized text by a first predetermined length comprises:
performing segmentation on the recognized text with an N-gram model, wherein N is the first predetermined length.

10. (canceled)

11. A non-transitory computer-readable medium storing a computer program thereon, wherein the program, when executed by a processing device, implements acts comprising:
performing text recognition on a target image, to obtain a recognized text;
performing segmentation processing on the recognized text; and
obtaining, based on a text segment obtained from the segmentation processing, a target text by correcting the recognized text through a pre-trained language model.

12. An electronic device, comprising:
a storage device having a computer program stored thereon; and
a processing device configured to execute the computer program in the storage device to implement acts comprising:
performing text recognition on a target image, to obtain a recognized text;
performing segmentation processing on the recognized text; and
obtaining, based on a text segment obtained from the segmentation processing, a target text by correcting the recognized text through a pre-trained language model.

13. The non-transitory computer-readable medium of claim 11, wherein performing segmentation processing on the recognized text comprises at least one of three segmentation modes:
performing segmentation on the recognized text by characters;
performing segmentation on the recognized text by a first predetermined length, wherein the first predetermined length is greater than 1; and
performing segmentation on the recognized text by a sliding window of a second predetermined length, wherein the second predetermined length is greater than 1.

14. The non-transitory computer-readable medium of claim 11, wherein performing segmentation processing on the recognized text comprises at least two of the three segmentation modes; and
obtaining, based on a text segment obtained from the segmentation processing, a target text by correcting the recognized text through a pre-trained language model comprises:
for each first target segmentation mode, inputting a text segment obtained from segmentation in the first target segmentation mode into the pre-trained language model, to obtain a first corrected text corresponding to the recognized text, wherein the first target segmentation mode is a segmentation mode adopted in the segmentation processing of the recognized text; and
generating the target text based on each of the first corrected texts.

15. The non-transitory computer-readable medium of claim 14, wherein generating the target text based on each of the first corrected texts comprises any of:
determining a first corrected text with a highest confidence among respective ones of the first corrected texts as the target text;
inputting the first corrected text with the highest confidence among the respective ones of the first corrected texts into the language model to obtain the target text; and
inputting each of the first corrected texts into the language model to obtain the target text.

16. The non-transitory computer-readable medium of claim 11, wherein obtaining, based on a text segment obtained from the segmentation processing, a target text by correcting the recognized text through a pre-trained language model comprises:
inputting the text segment obtained from the segmentation processing into the pre-trained language model, to correct the recognized text and obtain the target text.

17. The non-transitory computer-readable medium of claim 11, further comprising:
performing named entity recognition on the recognized text, to obtain at least one named entity; and
obtaining, based on a text segment obtained from the segmentation processing, a target text by correcting the recognized text through a pre-trained language model comprises:
obtaining, based on the text segment obtained from the segmentation processing and the at least one named entity, the target text by correcting the recognized text through the pre-trained language model.

18. The non-transitory computer-readable medium of claim 17, wherein performing segmentation processing on the recognized text comprises:
performing segmentation on the recognized text by characters; and
performing segmentation on the recognized text by a first predetermined length, and/or by a sliding window of a second predetermined length, wherein the first predetermined length and the second predetermined length are each greater than 1; and
obtaining, based on the text segment obtained from the segmentation processing and the at least one named entity, the target text by correcting the recognized text through the pre-trained language model comprises:
obtaining a second corrected text corresponding to the recognized text by inputting the text segments obtained from the segmentation by characters and the at least one named entity into the pre-trained language model;
for each second target segmentation mode, inputting a text segment obtained from segmentation in the second target segmentation mode into the language model to obtain a third corrected text corresponding to the recognized text, wherein the second target segmentation mode is a segmentation mode adopted in the segmentation processing of the recognized text other than the mode for segmenting the recognized text by characters; and
generating the target text based on the second corrected text and each of the third corrected texts.

19. The non-transitory computer-readable medium of claim 17, wherein obtaining the target text by correcting the recognized text through the pre-trained language model based on the text segment obtained from the segmentation processing and the at least one named entity comprises:
correcting the recognized text and obtaining the target text, by inputting the text segment obtained from the segmentation processing and the at least one named entity into the pre-trained language model.

20. The non-transitory computer-readable medium of claim 13, wherein performing segmentation on the recognized text by a first predetermined length comprises:
performing segmentation on the recognized text with an N-gram model, wherein N is the first predetermined length.

21. The device of claim 12, wherein performing segmentation processing on the recognized text comprises at least one of three segmentation modes:
performing segmentation on the recognized text by characters;
performing segmentation on the recognized text by a first predetermined length, wherein the first predetermined length is greater than 1; and
performing segmentation on the recognized text by a sliding window of a second predetermined length, wherein the second predetermined length is greater than 1.
